(19) United States
(12) Patent Application Publication
(10) Pub. No.: US 2008/0233937 A1
(43) Pub. Date: Sep. 25, 2008

(54) Mobile communication terminal and method

(76) Inventors: Marja-Leena Nurmela, Routio (FI); Heini Tuorila, Oulu (FI); Dominick Reed, Brinkley (GB)

Correspondence Address: PERMAN & GREEN, 425 POST ROAD, FAIRFIELD, CT, 06824, US

(21) Appl. No.: 11/429,922

(22) Filed: May 8, 2006

(51) Int. Cl. H04M 3/00

(52) U.S. Cl. 455/418

(57) ABSTRACT

It is presented a method for providing a user interface of a mobile communication terminal comprising a mode switch actuator, where the mobile communication terminal has at least two operational modes. The method comprises the: detecting an actuation of the mode switch actuator; determining a first operational mode being a currently active operational mode; determining a second operational mode to switch to; and switching operational mode of the mobile communication terminal from the first operational mode to the second operational mode. This provides a user interface which may be different for each operational mode, enhancing usability by excluding user interface items that are unnecessary for each operational mode. Corresponding multimode devices and computer program product are also presented.

### FIELD OF THE INVENTION

The aspects of the invention generally relate to mobile terminals and more particularly to user interfaces of mobile terminals.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc. Furthermore, the modern terminals have local connectivity abilities, such as Bluetooth, allowing the mobile terminals to communicate with a wide array of devices.

With this great number of applications, user interaction naturally becomes complex and somewhat difficult.

In the prior art, one attempt to simplify for users is to use two dimensional menus, allowing the user to see a large number of selectable applications simultaneously. However, switching from one application to the next is still a process which requires relatively intense attention by the user, even for the most common applications.

Consequently, there is a need to provide a mobile communication terminal and method providing a user interface with simpler and more intuitive selection of the most common applications.

### SUMMARY OF THE INVENTION

In view of the above, an objective of the invention is to solve or at least reduce the problems discussed above.

Generally, the above objectives are achieved by the attached independent patent claims.

According to a first aspect of the invention there has been provided a method for providing a user interface of a mobile communication terminal, comprising a mode switch actuator, the mobile communication terminal having at least two operational modes, the method comprising: detecting an actuation of the mode switch actuator; determining a first operational mode being a currently active operational mode; determining a second operational mode to switch to; and switching operational mode of the mobile communication terminal from the first operational mode to the second operational mode. This provides a user interface which may be different for each operational mode, enhancing usability by excluding user interface items that are unnecessary for each operational mode.

A main user application of the mobile communication terminal may differ between the first operational mode and the second operational mode. In other words, the first operational mode has one main intended use for the mobile communication terminal, and the second operational mode has another main intended use for the mobile communication terminal.

The mobile communication terminal may furthermore comprise a keypad comprising keys, and functions associated with at least one of the keys of the keypad differ between the first operational mode and the second operational mode. The keypad functions are thus customized for each operational mode.

A menu system of the mobile communication terminal may differ between the first operational mode and the second operational mode. The menu system is thus customized for each operational mode.

An idle screen of the mobile communication terminal may differ between the first operational mode and the second operational mode. The idle screen is thus customized for each operational mode.

The switching operational mode may involve switching a mode indication from a first mode indication to a second mode indication.

The first mode indication may include a first color scheme and the second mode indication may include a second color scheme, the second color scheme being distinct from the first color scheme.

The first color scheme may comprise a first color of a light by a multi-directional input device of the mobile communication terminal and the second color scheme may comprise a second color of a light by the multi-directional input device of the mobile communication terminal, the second color being distinct from the first color.

The first mode indication may include a first background of a display of the mobile communication terminal, and the second mode indication may include second background of the display, the second background being distinct from the first background.

The first mode indication may include using a first theme used on a display of the mobile communication terminal, and the second mode indication may include second theme used on the display, the second theme being distinct from the first theme.

The first mode indication may include highlighting, on a display of the mobile communication terminal, an icon representing the first operational mode and the second mode indication may include highlighting, on the display, an icon representing the second operational mode.

The first mode indication may include a first sound scheme and the second mode indication may include a second sound scheme, the second sound scheme being distinct from the first sound scheme.

The second sound scheme may differ from the first sound scheme by having different sounds associated with a same user interface event.

The second sound scheme may differ from the first sound scheme by having different sounds effects applied to a common original sound associated with a same user interface event, for at least one user interface event.

The switching operational mode may involve presenting a user indication.

The user indication may comprise at least one user indication selected from the group comprising a visual indication, an audible indication and a tactile indication.

The determining a second operational mode to switch to may involve: determining the second operational mode to switch to as a next operational mode after the currently active operational mode in a predefined circular list of operational modes.

The predefined circular list of operational modes may comprise three operational modes.

The three operational modes may be a phone mode, an exercise mode and a media player mode.

The determining a second operational mode may involve: if the actuation is detected to be shorter than a threshold time, determining the second operational mode to be a next operational mode in a predefined circular list of operational modes, and if the actuation is detected to be longer than a threshold time, determining the second operational mode to be a default operational mode.

A second aspect of the invention is a multimode device having at least two operational modes comprising: a mode switch actuator and a controller, wherein: the controller is configured to detect an actuation of the mode switch actuator; the controller is configured to determine a first operational mode being a currently active operational mode; the controller is configured to determine a second operational mode to switch to; and the controller is configured to, once the first and second operational modes have been determined, switch operational mode of the multimode device from the first operational mode to the second operational mode.

The multimode device may be a mobile communication terminal.

The controller may be configured to determine the second operational mode as a next operational mode after the currently active operational mode in a predefined circular list of operational modes.

The predefined circular list of operational modes may comprise three operational modes.

The three operational modes may be a phone mode, an exercise mode and a media player mode.

The mode switch actuator may be a button capable of being in a first position and a second position, and the button may be biased to the first position.

A third aspect of the invention is a multimode device having at least two operational modes comprising: a mode switch actuator; a controller; means for detecting an actuation of the mode switch actuator; means for determining a first operational mode being a currently active operational mode; means for determining a second operational mode to switch to; and means for switching operational mode of the multimode device from the first operational mode to the second operational mode.

The multimode device may be a mobile communication terminal.

A fourth aspect of the invention is a computer program product comprising software instructions that, when executed in a multimode device, performs the method according to the first aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the present invention may be applied.

FIG. 2a is a schematic front view illustrating a mobile terminal according to an embodiment of the present invention.

FIG. 2b is a schematic side view illustrating the mobile terminal in FIG. 2a.

FIG. 3 is a schematic block diagram representing an internal component, software and protocol structure of the mobile terminal shown in FIGS. 2a and 2b.

FIG. 4 is a schematic diagram showing how operational modes can be switched in an embodiment of the present invention.

### DETAILED DESCRIPTION OF THE INVENTION

The aspects of the invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

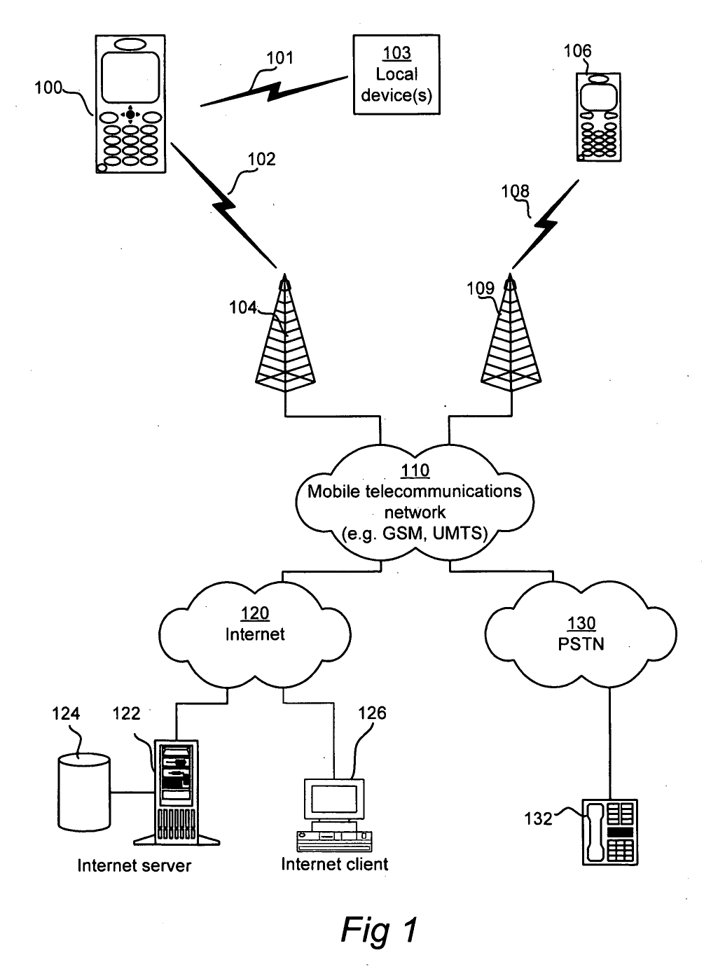

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

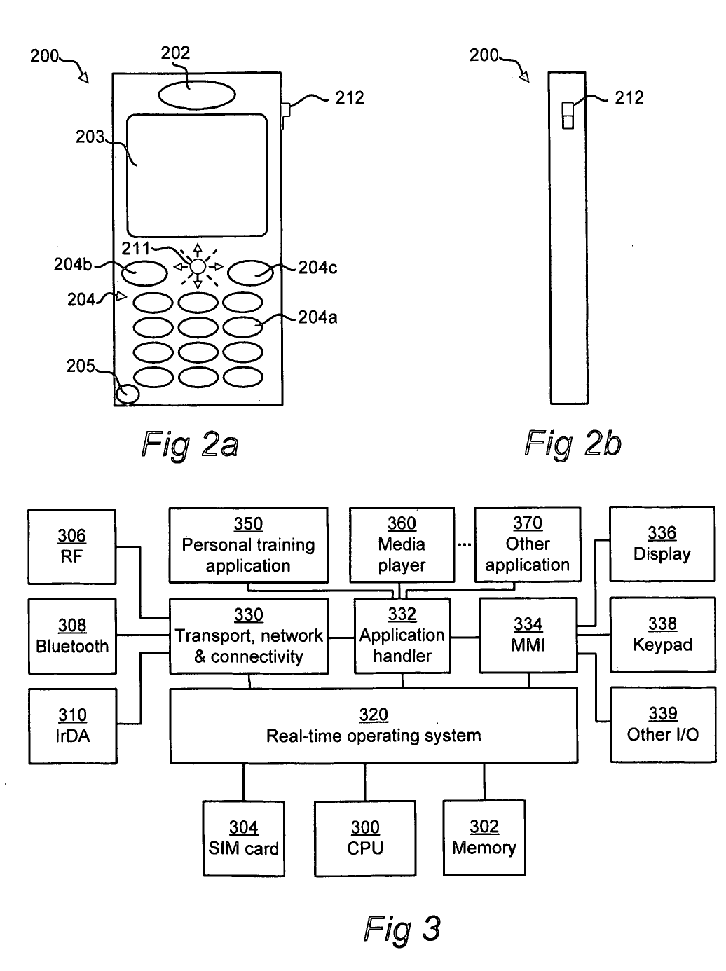

An embodiment 200 of the mobile terminal 100 is illustrated in more detail in FIG. 2a. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

A mode switch button 212 is also provided, as can be seen more clearly in FIG. 2b. The button is used to switch an operating mode of the mobile terminal. In this embodiment, the button is by default positioned in an upper position. When the user wants to switch modes, the button is moved to a lower position and released, after which the button returns to the default upper position by mechanical means, such as a spring or similar. As the man skilled in the art will realize, the functionality of the mode switch button could easily be replaced with a push button or any other suitable type of input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications can include a personal exercise application 350, a media player application 360, as well as various other applications 370, such as applications for voice calling, video calling, sending and receiving SMS, MMS or email, web browsing, an instant messaging application, a phone book application, a calendar application, a control panel application, a camera application, one or more video games, a notepad application, etc.

The MMI 334 also includes one or more hardware controllers, which together with the MMI drivers cooperate with the display 336/203, keypad 338/204 as well as various other I/O devices such as mode switch button 212, microphone 205, speaker 202, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

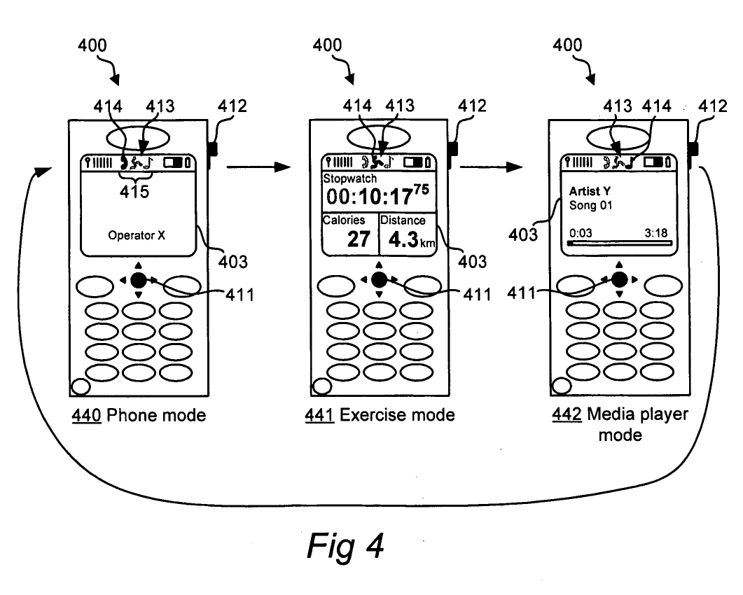

FIG. 4 shows how operational modes can be switched in an embodiment of the present invention. The mobile terminal 400, such as mobile terminal 200 of FIG. 2a, comprises a display 403, such as display 203 of FIG. 2a, a joystick 411, such as joystick 211 of FIG. 2a, and a mode switch button 412 such as mode switch button 212 of FIG. 2a, to allow the user to switch operational modes.

Operational modes are modes where the mobile terminal 400 behaves in specific ways. For example, FIG. 4 shows 3 operational modes: a phone mode 440, an exercise mode 441 and a media player mode 442. Each operational mode allows the mobile terminal to focus on a main user application, or functionality of that mode, allowing for predictable use. Each operational mode can change the behavior of the keypad, menu structure and idle screen.

When the mobile terminal 400 is in the phone mode 440, the mobile terminal behaves as a user would expect a regular mobile terminal to behave. In other words, a menu system and/or shortcuts allow the user to instruct the mobile terminal to perform a desired function, such as voice telephony, www/wap browsing, video telephony, electronic messaging (e.g. SMS, MMS, email, instant messaging), digital image or video recording, electronic games, calendar/organizer/time planner, word processing, etc.

When the mobile terminal 400 is in the exercise mode 441, the main purpose of the mobile terminal is to provide the user with applications related to the physical exercise of the user.

In one embodiment, an accelerometer is integrated in the mobile terminal 400. In another embodiment, an external accelerometer is connected to the mobile terminal 400, e.g. over a local link, such as the local link 101 in FIG. 1. The accelerometer can detect acceleration and thereby steps that the user takes while the mobile terminal is carried by the user. When an accelerometer is integrated or connected to the mobile terminal 400, the mobile terminal automatically measures movement during the day. If the user previously has entered personal information, such as weight, height, etc., the mobile terminal 400 can convert the data from the accelerometer to other measurements, such as covered distance and burnt calories. Optionally, a GPS (Global Positioning System) sensor can be either integrated in, or connected to, the mobile terminal 400 to allow accurate distance measurement. Also, an external heart beat monitor can be connected to the mobile terminal 400 to detect heart beats and calculate heart rate.

When the mobile terminal 400 is in the media player mode 442, the main purpose of the mobile terminal is to play media to the user. For example, the media player can play music or sound files, such as MP3 (mpeg-1 audio layer 3) files, AAC (advanced audio coding) files or ogg files. Optionally, the media player can also be used to listen to FM (frequency modulated) radio, or to play video files according to standards such as MPEG-2, MPEG-4 or H.323.

As the user switches operational modes with mode switch button 412, the modes are switched serially. In the illustrated embodiment, there is a circular list of operational modes consisting of the phone mode 440, the exercise mode 441, and the media player mode 442, in that order. Consequently, if the mobile terminal 400 is in the phone mode 440 and the user actuates the mode switch button 412, the phone switches to the exercise mode 441. Similarly, if the mobile terminal 400 is in the exercise mode 441 and the user actuates the mode switch button 412, the phone switches to the media player mode 442. Finally, if the mobile terminal 400 is in the media player mode 443 and the user actuates the mode switch button 412, the phone loops back and switches to the phone mode 440.

To allow the user to easily determine what mode is currently used, elements of the user interface are specific for each mode. There are a multitude of distinguishing user interface elements that can vary to allow the user to see what mode is currently active, e.g., a centrally located light by the joystick 411 can change color, the background on the display 403 can have different colors or appearances, or the entire theme of the user interface with colors and fonts can change. In one embodiment, one icon 414 of a set of icons 415 at the top of the display 403 is highlighted to indicate which mode is active.

Mode changes can also change sound effects. For example in phone mode 440, the sounds may be discrete or even absent for actions such as button press, enter menu, exit menu, while in exercise mode 441, distinct and loud sounds are played for these actions to give clear feedback to the user while exercising. The media player mode 441 may have a totally different, more cool or ambient sound scheme on the actions mentioned in order to give feedback to the user on actions performed, while still not excessively disturbing the experience of listening to music. Optionally, the sound scheme can furthermore vary depending on whether headphones are connected to the mobile terminal 400 or not. The changes of sounds does not need to be totally different sounds; the changes could be effects applied to sounds. For example, a sound for a button press in phone mode could be reused in the media player mode, with a strong reverberation effect on it to give a more ambient effect while still providing familiarity to the user.

Additionally, a temporary user indication can be given when the actual mode change occurs. For example, the vibrator may vibrate on a mode change, where the vibration is either always identical for all modes or every mode has a particular vibration associated with it. Additionally, a dialog can show the name of the new operational mode in the display 403, or a sound effect or speech synthesizer pronouncing the new mode can be played to the user.

It is to be noted that although the modes can be switched, certain appropriate processing of an inactive mode can still be performed. For example, the exercise application can count the steps of the user in the background, regardless of what mode the mobile terminal is in. Similarly, the media player can let the user hear an FM radio station while the mobile terminal is in exercise mode, or the phone application can temporarily interrupt current processing if an incoming phone call is detected.

While the embodiment of the invention is described above as embodied in a mobile terminal, the invention can be implemented in any type of multimode device.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for providing a user interface of a mobile communication terminal, comprising a mode switch actuator, said mobile communication terminal having at least two operational modes, said method comprising:
detecting an actuation of said mode switch actuator;
determining a first operational mode being a currently active operational mode;
determining a second operational mode to switch to; and
switching operational mode of said mobile communication terminal from said first operational mode to said second operational mode.

2. The method according to claim 1, wherein a main user application of said mobile communication terminal differs between said first operational mode and said second operational mode.

3. The method according to claim 1, wherein said mobile communication terminal furthermore comprises a keypad comprising keys, and functions associated with at least one of said keys of said keypad differ between said first operational mode and said second operational mode.

4. The method according to claim 1, wherein a menu system of said mobile communication terminal differs between said first operational mode and said second operational mode.

5. The method according to claim 1, wherein an idle screen of said mobile communication terminal differs between said first operational mode and said second operational mode.

6. The method according to claim 1, wherein said switching operational mode involves switching a mode indication from a first mode indication to a second mode indication.

7. The method according to claim 6, wherein said first mode indication includes a first color scheme and said second mode indication includes a second color scheme, said second color scheme being distinct from said first color scheme.

8. The method according to claim 7, wherein said first color scheme comprises a first color of a light by a multi-directional input device of said mobile communication terminal and said second color scheme comprises a second color of a light by said multi-directional input device of said mobile communication terminal, said second color being distinct from said first color.

9. The method according to claim 6, wherein said first mode indication includes a first background of a display of said mobile communication terminal, and said second mode indication includes second background of said display, said second background being distinct from said first background.

10. The method according to claim 6, wherein said first mode indication includes using a first theme used on a display of said mobile communication terminal, and said second mode indication includes second theme used on said display, said second theme being distinct from said first theme.

11. The method according to claim 6, wherein said first mode indication includes highlighting, on a display of said mobile communication terminal, an icon representing said first operational mode and said second mode indication includes highlighting, on said display, an icon representing said second operational mode.

12. The method according to claim 6, wherein said first mode indication includes a first sound scheme and said second mode indication includes a second sound scheme, said second sound scheme being distinct from said first sound scheme.

13. The method according to claim 12, wherein said second sound scheme differs from said first sound scheme by having different sounds associated with a same user interface event.

14. The method according to claim 12, wherein said second sound scheme differs from said first sound scheme by having different sounds effects applied to a common original sound associated with a same user interface event, for at least one user interface event.

15. The method according to claim 1, wherein said switching operational mode involves presenting a user indication.

16. The method according to claim 15, wherein said user indication comprises at least one user indication selected from the group comprising a visual indication, an audible indication and a tactile indication.

17. The method according to claim 1, wherein said determining a second operational mode to switch to involves:
determining said second operational mode to switch to as a next operational mode after said currently active operational mode in a predefined circular list of operational modes.

18. The method according to claim 17, wherein said predefined circular list of operational modes comprises three operational modes.

19. The method according to claim 18, wherein said three operational modes are a phone mode, an exercise mode and a media player mode.

20. The method according to claim 1, wherein said determining a second operational mode involves:
if said actuation is detected to be shorter than a threshold time, determining said second operational mode to be a next operational mode in a predefined circular list of operational modes, and if said actuation is detected to be longer than a threshold time, determining said second operational mode to be a default operational mode.

21. A multimode device having at least two operational modes comprising: a mode switch actuator and a controller, wherein:
said controller is configured to detect an actuation of said mode switch actuator;
said controller is configured to determine a first operational mode being a currently active operational mode;
said controller is configured to determine a second operational mode to switch to; and
said controller is configured to, once said first and second operational modes have been determined, switch operational mode of said multimode device from said first operational mode to said second operational mode.

22. The multimode device according to claim 21, wherein said multimode device is a mobile communication terminal.

23. The multimode device according to claim 21, wherein said controller is configured to determine said second operational mode as a next operational mode after said currently active operational mode in a predefined circular list of operational modes.

24. The multimode device according to claim 23, wherein said predefined circular list of operational modes comprises three operational modes.

25. The multimode device according to claim 24, wherein said three operational modes are a phone mode, an exercise mode and a media player mode.

26. The multimode device according to claim 21, wherein:
said mode switch actuator is a button capable of being in a first position and a second position, and
said button is biased to the first position.

27. A multimode device having at least two operational modes comprising:
a mode switch actuator;
a controller;
means for detecting an actuation of said mode switch actuator;
means for determining a first operational mode being a currently active operational mode;
means for determining a second operational mode to switch to; and
means for switching operational mode of said multimode device from said first operational mode to said second operational mode.

28. The multimode device according to claim 27, wherein said multimode device is a mobile communication terminal.

29. A computer program product comprising software instructions that, when executed in a multimode device, performs the method according to claim 1.
